(19) United States
(12) Patent Application Publication
(10) Pub. No.: US 2002/0166249 A1
(43) Pub. Date: Nov. 14, 2002

(54) Laser level device

(76) Inventor: Ying-Chou Liao, Ta-Li City (TW)

Correspondence Address: Charles E. Baxley, Hart, Baxley, Daniels & Holton, Fifth Floor, 59 John Street, New York, NY, 10038, US

(21) Appl. No.: 09/853,182

(22) Filed: May 11, 2001

(51) Int. Cl. G01C 15/00; G01C 9/00

(52) U.S. Cl. 33/451; 33/286

(57) ABSTRACT

A laser level device includes a casing having a laser beam emitting device received therein and a tube is rotatably engaged with an end of the casing so that the laser beam generated from the laser beam emitting device enters in the tube. A reflection mirror is received in the tube so as to reflect the laser beam toward a polariscope connected to a peripheral wall of the tube. The tube can be rotated to adjust the position of the polarisocpe so as to obtain the reference lines at different positions.

### FIELD OF THE INVENTION

The present invention relates to a laser level device that employs a reflection mirror and a polariscope to generate a reference line and the carrier for receiving the reflection mirror and the polariscope can be rotated to adjust the position of the reference line.

A conventional laser level device for generating a reference line is shown in FIGS. 6 and 7 and generally includes an elongated casing 10 with a laser beam emitting device 11 received therein and a polariscope 12 is engaged with a tube that is connected to a front end of the casing 10. A laser beam is generated from the laser beam emitting device 11 and the beam is polarized to generate a reference line on a side of the casing 10. The users may use the reference line to be a reference base and other parts are then set their respective positions according the reference base. However, the conventional laser level device can only generate one reference line so that if the users need two or more reference lines at different latitude, the users have to remove the laser level device from one place to another and set the device all over again. This costs a lot of time and reduces efficiency. Another laser level device although can generate reference lines at different positions, it involves a complicated mechanical assembly and an electronic assembly. The mechanical assembly includes a motor and a gear system, and is controlled by the electronic assembly which is operated with complicated processes so that only professional persons can use it. Besides, the laser level device is heavy in weight so that it is not convenient for being transported and carried.

The present invention intends to provide a laser level device that has a simple mechanism and is easily to be operated. The laser level device can generate the reference lines at different latitude.

### SUMMARY OF THE INVENTION

In accordance with one aspect of the present invention, there is provided a laser level device and comprises a casing having a laser beam emitting device received therein and a tube is rotatably engaged with an end of the casing. The tube is located in alignment with the laser beam emitting device. A reflection mirror is received in the tube and a polariscope is connected to a peripheral wall of the tube.

The primary object of the present invention is to provide a laser level device that can generate a reference line at desired positions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a laser level device of the present invention;

FIG. 2 is a perspective view to show a tube on the casing of the laser level device of the present invention;

FIG. 3 is a cross sectional view to show the structure in the tube of the laser level device of the present invention;

FIG. 4 is an illustrative view to show a reference line is generated via the polariscope of the laser level device of the present invention;

FIG. 5 is an illustrative view to show that the laser level device of the present invention is oriented upright and a vertical reference line is generated;

FIG. 6 is a perspective view to show a conventional laser level device, and

FIG. 7 is a cross sectional view to show a tube on the conventional laser level device and a polariscope is engaged with the tube.

### DETAILED DESCRIPTION OF THE PREFERRED EMBODIMENT

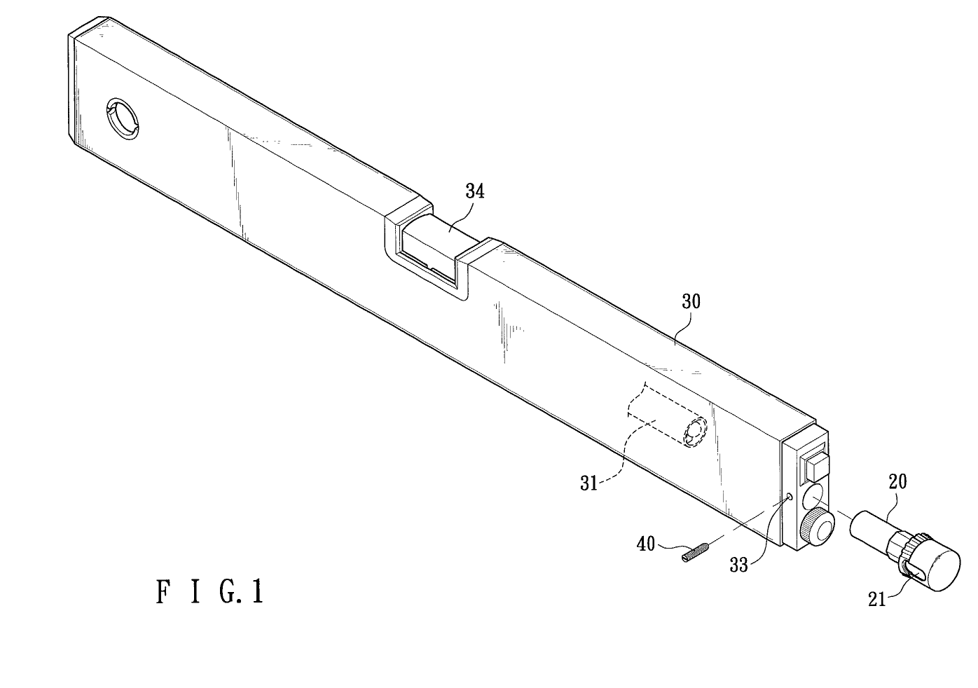

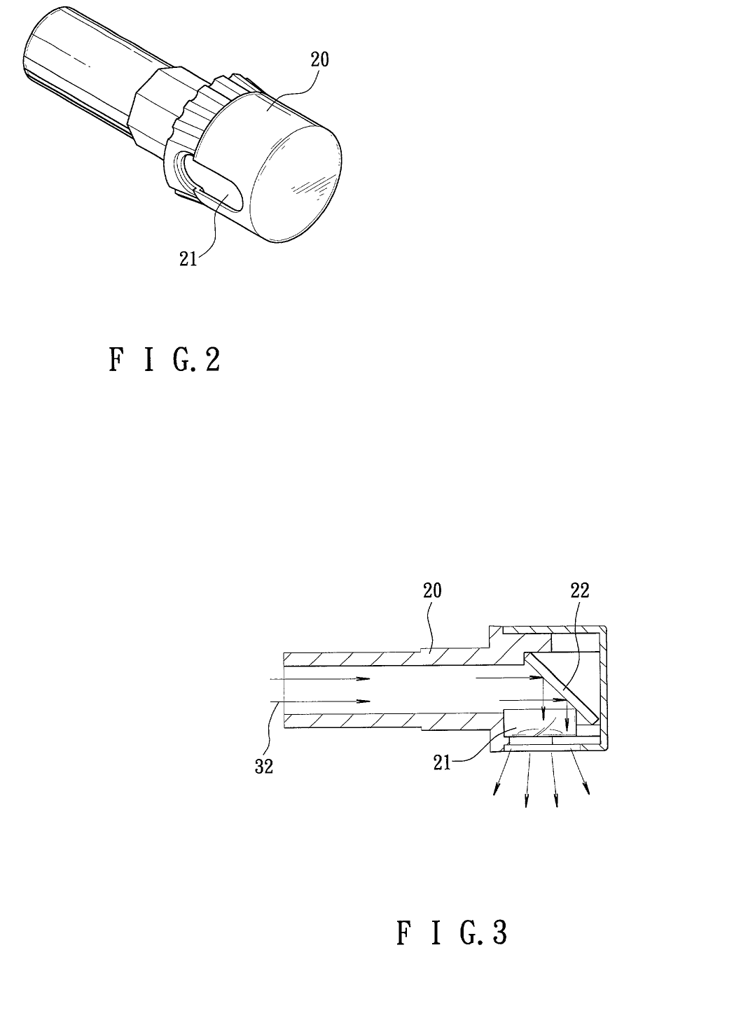

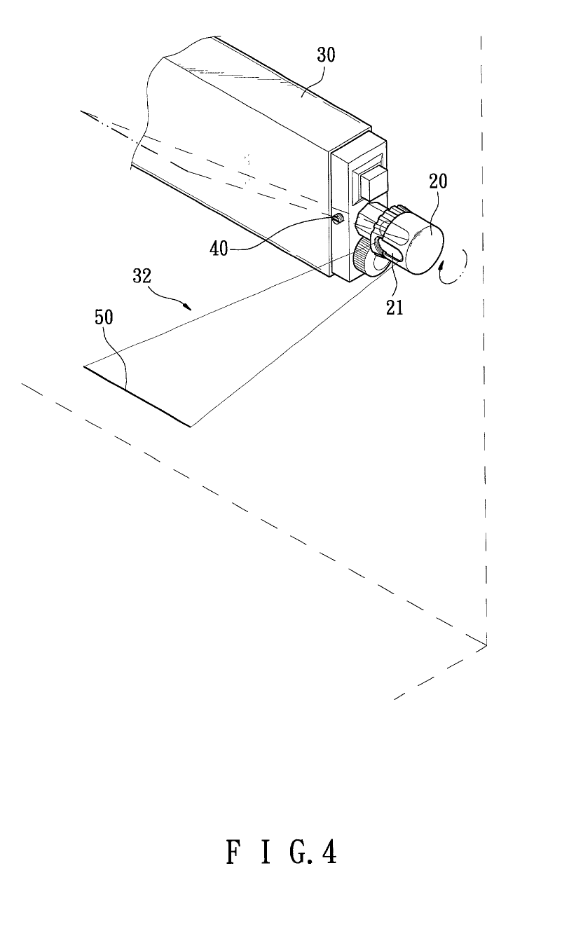

Referring to FIGS. 1 to 3, the laser level device of the present invention comprises an elongated casing 30 having a bubble level member 34 embedded in the casing 30 so that the casing 30 can be placed horizontally. A laser beam emitting device 31 is received therein and a tube 20 is rotatably engaged with an end of the casing 30. The tube 20 is located in alignment with the laser beam emitting device 31 so that a laser beam 32 generated by the laser beam emitting device 31 may enter into the tube 20. A bolt 40 extends through a hole 33 on a side of the casing 30 and contacts against the tube 20 to firmly position the tube 20 in position. A reflection mirror 22 is received in the tube 20 and the reflection surface of the reflection mirror 22 is located at 45 degrees with regard to a longitudinal axis of the tube 20. A polariscope 21 is connected to a peripheral wall of the tube 20 so that the laser beam 32 is reflected when hitting on the reflection surface of the reflection mirror 22 and goes through the polariscope 21 and forms a reference line 50 on a side of the tube 20 as shown in FIG. 4.

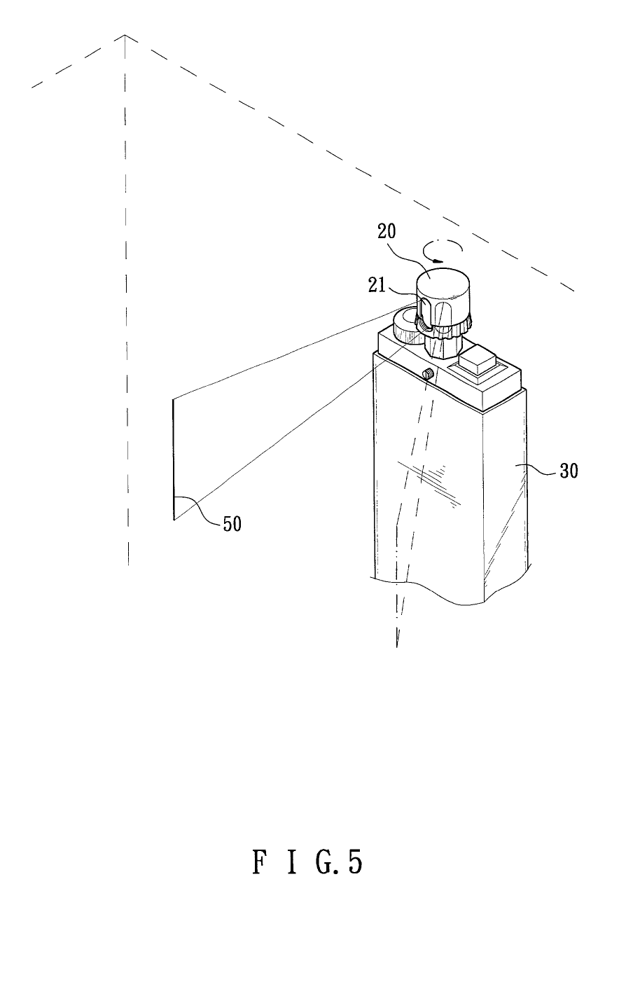

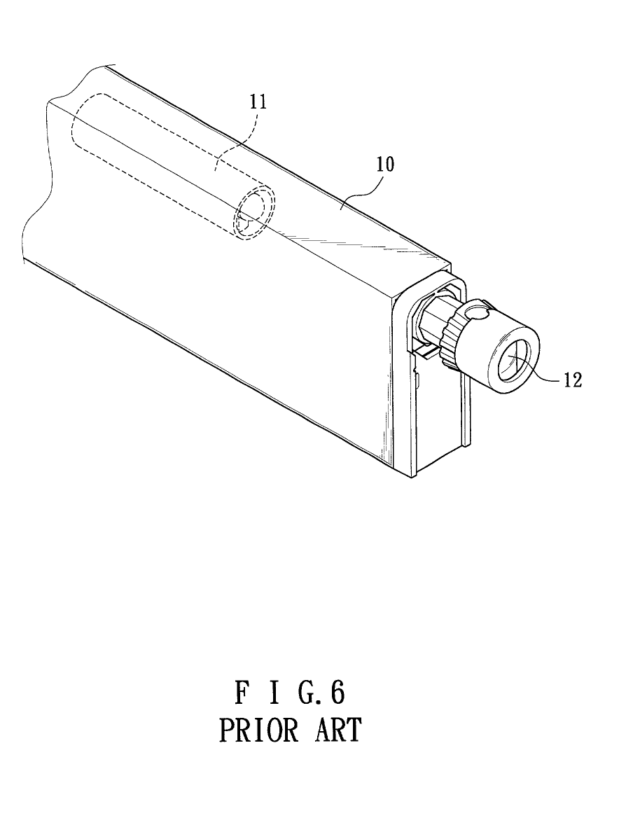

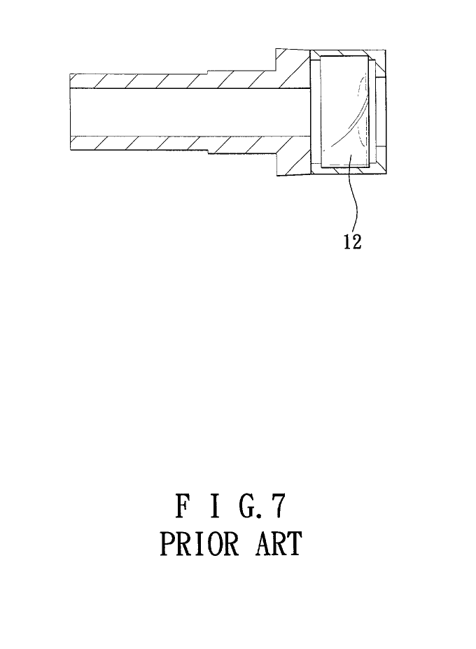

As shown in FIG. 5, the casing 30 may be put in an upright position and the tube 20 is rotated an angle by unscrewing the bolt 40 first, the polariscope 21 is shifted with the tube 20 so that the reference line 50 can be shown at a different position.

The laser level device is easily to use and can provide the reference line 50 at different latitude simply by rotating the tube 20.

While we have shown and described the embodiment in accordance with the present invention, it should be clear to those skilled in the art that further embodiments may be made without departing from the scope of the present invention.

WHAT IS CLAIMED IS:

1. A laser level device comprising:
a casing having a laser beam emitting device received therein and a tube rotatably engaged with an end of said casing, said tube located in alignment with said laser beam emitting device, a reflection mirror received in said tube and a polariscope connected to a peripheral wall of said tube.

2. The laser level device as claimed in claim 1 further comprising a bolt extending through said casing and contacting against said tube.

3. The laser level device as claimed in claim 1 further comprising a bubble level member embedded in said casing.
